(19) United States
(12) Patent Application Publication
(10) Pub. No.: US 2009/0287537 A1
(43) Pub. Date: Nov. 19, 2009

(54) Dynamic bidding and ranking system

(76) Inventor: Eugene Villoso, Las Vegas, NV (US)

Correspondence Address: Eugene Villoso, 11366 Sandstone Ridge Dr., Las Vegas, NV, 89135, US

(21) Appl. No.: 12/287,362

(22) Filed: Oct. 8, 2008

Related U.S. Application Data
(60) Provisional application No. 61/127,505, filed on May 14, 2008.

(51) Int. Cl. G06Q 10/00; G06Q 50/00

(52) U.S. Cl. 705/10

(57) ABSTRACT

The present invention relates to certain bidding and ranking systems, which may be used to rank objects in a computing environment, such as, for example, bidding and ranking systems that may be used to rank on-line advertisements. According to certain embodiments of the invention, such methods of ranking objects comprise receiving input values from a plurality of users. Each input value is preferably correlated with an object during a defined time interval, and each object is associated with a single user. The method further comprises calculating a sum of the input values associated with each object at defined time points, and then ranking each object, at each time point, based on the sum of the input values associated with each object.

### CROSS-REFERENCE TO RELATED APPLICATIONS

This application claims priority to, and incorporates by reference, U.S. provisional patent application Ser. No. 61/127,505, filed May 14, 2008.

### FIELD OF THE INVENTION

The field of the present invention relates to certain bidding and ranking systems, which may be used to rank objects in a computing environment, such as, for example, bidding and ranking systems that may be used to rank on-line advertisements.

### BACKGROUND OF THE INVENTION

The field of e-commerce has become fiercely competitive over the past several years as numerous businesses, both new and old, have started offering goods for sale within websites and other on-line environments. Indeed, in 2007, several billions of dollars in products were estimated to have been sold over the internet. As a result, there is an ongoing and rapidly growing need for businesses to implement procedures that attract customers to their websites, advertise their goods and services, and encourage consumers to purchase such goods and services. Of course, there have been numerous types of on-line advertising techniques used to promote the sale of goods and services, ranging from basic pay-per-click advertising and pop-up ads to other more complicated schemes, such as on-line games having an advertising component incorporated therein.

A fundamental aspect of these advertising methods (and basic business directories and internet search result listings) is the method by which on-line advertisements, business listings, website links, and other objects are ranked in an on-line environment. Indeed, the value in being ranked near the top of, for example, internet advertisement listings, business directories, and basic internet search results has been appreciated for many years. There is a constant battle among businesses to be ranked near the top, as research shows that higher-ranked listings are accessed by consumers much more frequently than lower-ranked listings. Obviously, this translates into more business.

The methods and systems that are often employed to rank such objects are often cumbersome, subject to being influenced by inappropriate or irrelevant factors, and are largely out of the control of the business entities (or persons) being ranked. In light of the foregoing, there is a continuing need for new and improved methods of ranking such objects in a computing environment.

### SUMMARY OF THE INVENTION

According to certain aspects of the present invention, methods for ranking objects in a computing environment are provided. According to certain embodiments of the invention, such methods of ranking objects comprise receiving input values from a plurality of users. Each input value is preferably correlated with an object during a defined time interval, and each object is preferably associated with a single user. The input values may correspond to, for example, monetary values. The methods further comprise calculating a sum of the input values associated with each object at defined time points, and then ranking each object based on the sum of the input values associated therewith.

According to further aspects of the present invention, specific applications for the methods (and bidding and ranking systems) described herein are provided, which are particularly designed for, e.g., on-line advertisements and internet search keywords. More particularly, such aspects of the present invention may be used to rank on-line advertisements, or internet search results, in a computing environment. For example, such methods comprise receiving input values from a plurality of users, wherein each input value is preferably correlated with an advertisement (or internet search keyword) during a defined time interval and represents a monetary value. In such embodiments, each object will be associated with a single user, such as a business entity (or person(s) authorized to submit input values on behalf of a business entity). The method further comprises calculating a sum of the input values associated with each advertisement (or internet search keyword) at defined time points, and then ranking each advertisement based on the sum of the input values associated therewith.

According to still further aspects of the present invention, systems are provided that may be used to carryout the methods described herein. The systems of the present invention may generally comprise, for example, a server and a database, which together are capable of receiving the input values and deriving the value totals described herein, and generating a dynamic ranking of objects. The ranking may be displayed to users in a graphical user interface (e.g., a website) that may be accessed and viewed within any computing device, which also may constitute a part of the systems described herein.

The above-mentioned and additional features of the present invention are further illustrated in the Detailed Description contained herein.

### BRIEF DESCRIPTION OF THE FIGURES

FIG. 1 is a flow diagram that generally outlines the methods described herein.

FIG. 2 is another flow diagram that outlines certain steps of the methods described herein.

FIG. 3 is a flow diagram that outlines certain steps of the methods described herein, namely, the means by which object rankings and value totals are calculated.

FIG. 4 is a chart that illustrates certain aspects of the present invention, namely, the dynamic characteristics of the ranking systems described herein.

FIG. 5 is a chart that numerically illustrates the dynamic characteristics of the ranking systems described herein.

FIG. 6 is another chart that numerically illustrates the dynamic characteristics of the ranking systems described herein.

### DETAILED DESCRIPTION OF THE INVENTION

The following will describe in detail several preferred embodiments of the present. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

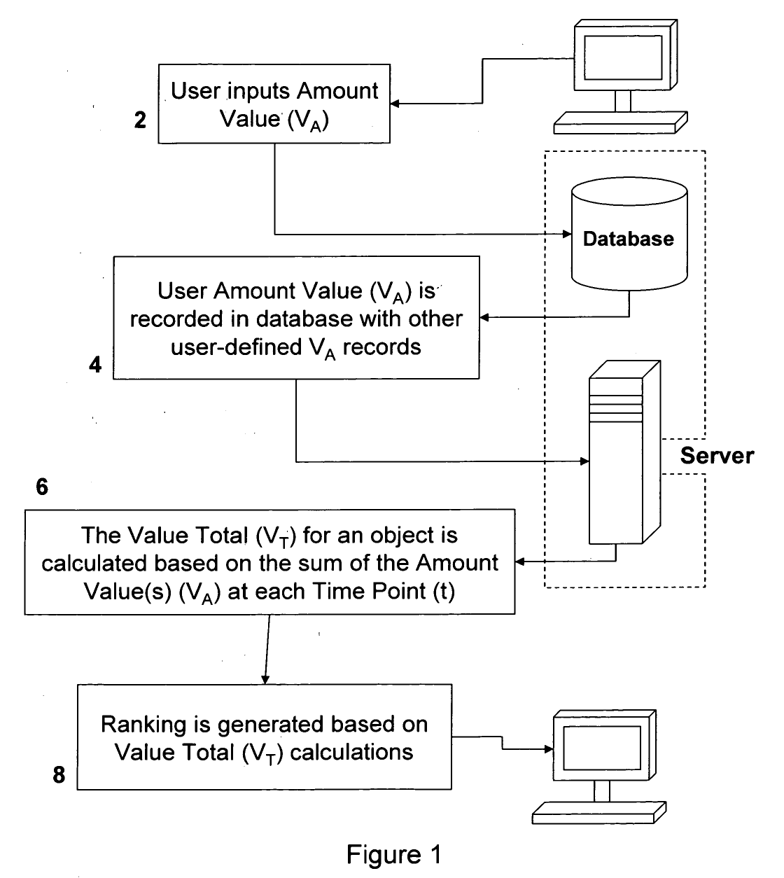

According to certain embodiments of the present invention, methods for ranking objects in a computing environment are provided. Referring to FIG. 1, for example, such methods of ranking objects generally comprise receiving input values (Amount Values (V_{A})) 2 from a plurality of users. Each input value (Amount Value (V_{A})) is correlated with a single object, and is preferably recorded and stored in a database 4 and correlated with the appropriate object. The input values (Amount Values (V_{A})) entered by other users (which are correlated with other objects, as described below) are also recorded and stored in the database 4. The input values may be submitted to the server which houses the database via, for example, a personal computer that may access the internet. Each input value recorded in the database is preferably correlated with an object during a defined time interval. As used herein, “time interval” or “defined time interval” generally means a period of time. More particularly, the database may house a table that contains a listing of different objects, with each object having corresponding Amount Values (V_{A}) assigned thereto by the authorized user, which are applicable within a defined and specified time interval.

The “object” may be any of a plurality of things which may be “ranked,” i.e., prioritized in the form of a list, within a computing environment, such as, for example, advertisements, personal names within a directory, business names within a directory, uniform resource locators (e.g., as listed within internet search results), bids, internet search keywords, or combinations thereof. The invention provides that each object is preferably associated with a single user, e.g., a single person or business entity. The defined time interval associated with each Amount Value (V_{A}) may be any definite period of time, but will preferably be in the form of commonly segregated blocks of time, such as minutes, hours, days, weeks, months, or years. In addition, the duration of the time interval may be (1) any period of time specified by a user (i.e., a person may specify any amount of time), (2) a period of time that a user selects from a standardized list of time interval options, or (3) a period of time that is automatically assigned by a computer server. For example, in the first two scenarios, the duration of the time interval may be selected and controlled by a user by entering any time interval within a text box, or selecting the desired time interval from a drop-down box listing a plurality of pre-defined options, within an internet-accessible form, which may then be submitted to a server and database housed therein. Still further, the time interval may be defined by enabling the user to specify a beginning and end date within an on-line calendar. The invention provides that other means for defining the total duration of the time interval may be employed, whether currently available or developed hereafter.

The methods of the present invention further comprise calculating 6 a sum of the input values (Amount Values (V_{A})) associated with each object at defined time points (t), with the sum being referred to herein as the “Value Total (V_{T}).” As used herein, the terms “time point(s)” and “time point(s) (t)” refer to a single moment in time, e.g., 12:00 p.m. (Noon) or 12:10:30 p.m. (ten minutes and thirty seconds past noon). More particularly, according to certain embodiments of the invention, the Value Total (V_{T}) for a single object (which is correlated with a single user) at a single time point (t) may be calculated according to the following equation: V_{T}(t)=V_{A1}(t)+V_{A2}(t) . . . V_{An}(t). It should be appreciated that, implicit in the foregoing equation, is the notion that each user is allowed to submit multiple input values (Amount Values (V_{A})) for a single object, which may or may not be within the same time interval. As such, if a user submits multiple input values (Amount Values (V_{A1} and V_{A2})), which apply (at least in part) to the same time interval, the Value Total (V_{T}) for such time interval will be the sum of V_{A1} and V_{A2}. Once the Value Totals (V_{T}) for all objects are calculated, a ranking of objects may be generated 8, which will preferably rank the objects from the highest to the lowest Value Totals (V_{T}) associated therewith.

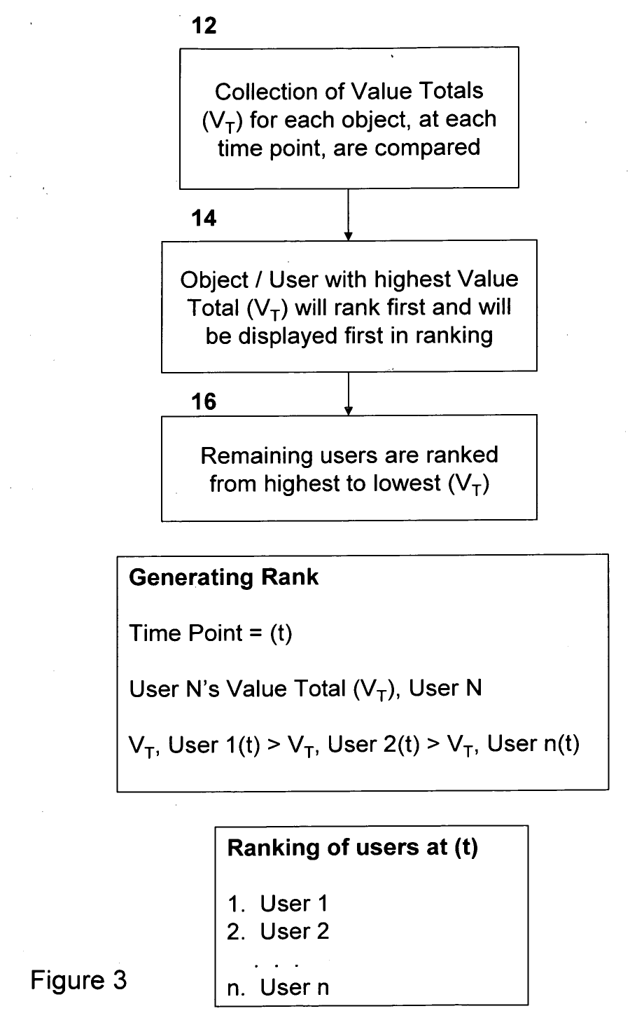

More particularly, and referring to FIG. 3, the Value Totals (V_{T}) for all objects are calculated and compared to each other 12. The object (or user associated with such object) having the highest Value Total (V_{T}) at the applicable time point (t) will be ranked first 14. The invention provides that all remaining objects (or users associated therewith) will be ranked below the object (user) having the highest Value Total (V_{T}), from the highest to the lowest Value Totals (V_{T}) 16.

In addition to ranking and listing objects from highest to lowest Value Totals (V_{T}), the invention provides that additional rules may be applied to influence the outcome of such ranking. For example, a threshold minimum Value Total (V_{T}) may be specified, such that only objects having Value Totals (V_{T}) of at least the threshold minimum will be ranked. In addition, the ranking system may segregate objects into a plurality of groups, with each group being assigned a range of Value Totals (V_{T}). In such embodiments, an object will be placed in (and/or ranked within) the group having a specified range of Value Totals (V_{T}) that encompass the calculated Value Total (V_{T}) for such object.

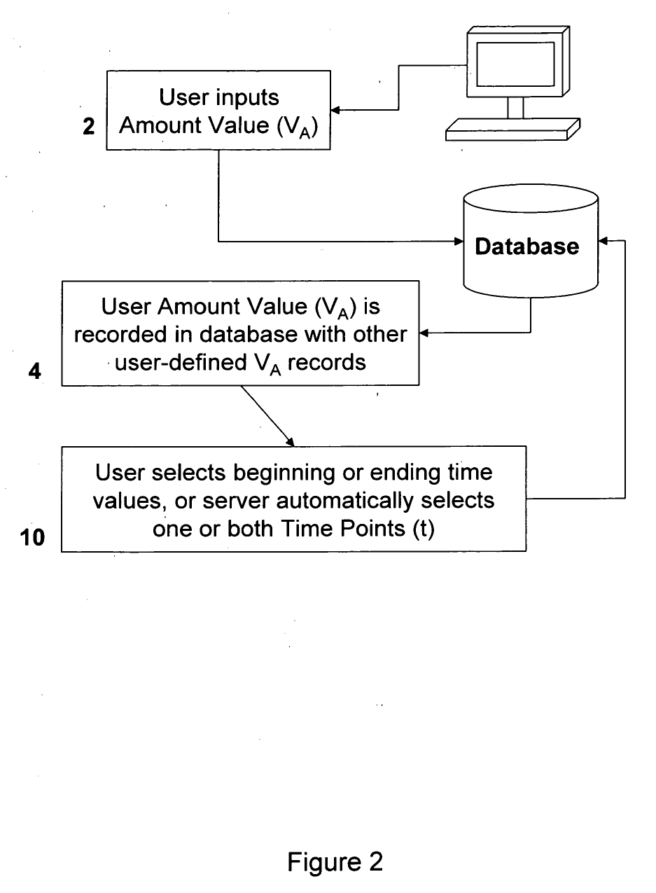

As mentioned above, each Amount Value (V_{A}) associated with an object will apply during a specified time interval. The invention provides that the beginning and end point for the specified time interval may be partially, or wholly, controlled by the user 10 (FIG. 2) specifying the time interval. More specifically, for example, the beginning point for the time interval for an input value (Amount Value (V_{A})) may be the date on which the input value is entered (selected by a user), while the user may also be allowed to select an end point for the time interval for the input value (e.g., 1 day, 30 days, or 90 days from the beginning point), such that the total period of time during which the input value (Amount Value (V_{A})) will be active may be controlled. Alternatively, the invention provides that the beginning point for the time interval for an input value (Amount Value (V_{A})) may also be selected by the user, such that the applicable input value may be deferred to begin at some point in the future.

In certain embodiments, when the Amount Value (V_{A}) represents a monetary value, the actual cost of the input value may be calculated by multiplying the Amount Value (V_{A}) by the specified time interval. For example, if a user inputs an Amount Value (V_{A}) of $2.00 per day, and the selected time interval is 30 days, the total actual cost of the input value will be $60.00. In other embodiments, the Amount Value (V_{A}) and time interval may not share the same metric. For example, the Amount Value (V_{A}) may be a price-per-click value for an on-line advertisement, whereas the specified time interval may be denominated in days. In this example, the total actual cost of the input value will be the number of clicks on the on-line advertisement that are recorded during the time interval. In some cases, when a plurality of users are submitting input values in a variety of different currencies, each input value may be converted into a standardized currency (based on applicable exchange rates), such that accurate comparisons may be achieved between such input values.

The invention provides that the Value Total (V_{T}) for each object is preferably calculated at defined time points (t), which may be every second, minute, hour, day, and so on. Alternatively, the invention provides that the Value Total (V_{T}) for each object may be calculated instantaneously upon a user requesting a ranking of objects. For example, when an internet user conducts a search using a keyword, the Value Total (V_{T}) for each object associated with such keyword may be immediately calculated, so that a current and accurate ranking of objects (e.g., internet search results) may be returned and displayed to the internet user. Accordingly, the invention provides that the methods of ranking objects described herein are dynamic, and the generated rankings may change from time-to-time based on the then-current Value Total (V_{T}) for each object.

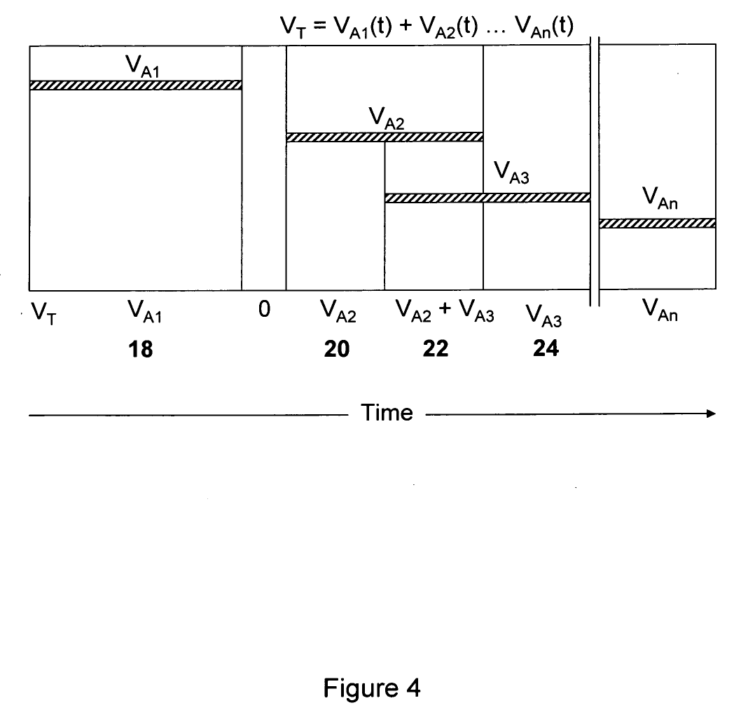

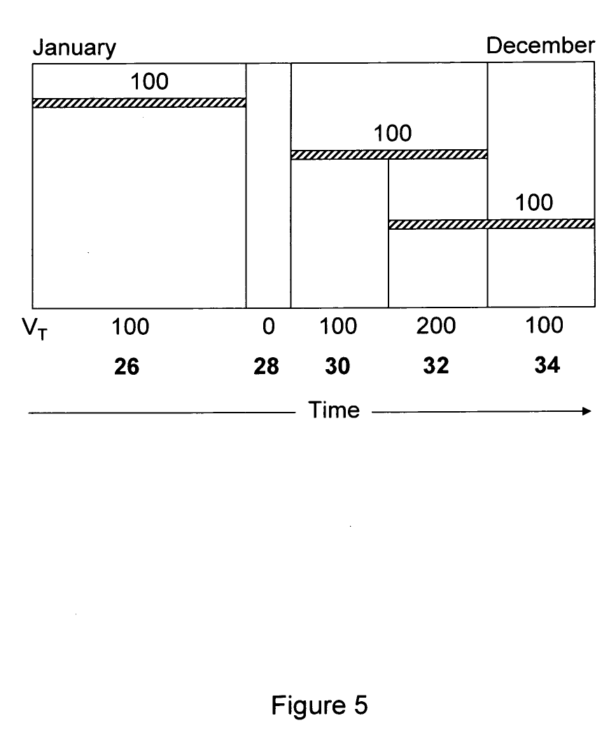

The dynamic nature of the ranking methods described herein is further illustrated in FIGS. 4 and 5. More specifically, FIG. 4 shows a plurality of input values (Amount Values (V_{A1}, V_{A2}, V_{A3}, and V_{An})) entered by a user, such that the input values are selected to apply to different parts of a time interval. As shown therein, for the purpose of calculating the Value Total (V_{T}) at different time points (t) within the time interval, the entire time interval (duration on V_{A1} 18 will apply by itself (i.e., it will not be added to any other input values). In contrast, approximately the first half of V_{A2} 20 will apply by itself, whereas the second half of V_{A2} 22 will be added to the first half of V_{A3}. As shown in FIG. 4, the second half of V_{A3} 24 will apply by itself (i.e., it will not be added to any other input values). FIG. 5 illustrates the foregoing concept numerically. That is, if each of V_{A1}, V_{A2}, and V_{A3} are assigned a value of 100, then the Value Total (V_{T}) at time points 26, 28, 30, 32, and 34 will be 100, 0, 100, 200 and 100, respectively. Accordingly, depending on the Value Totals (V_{T}) of the other objects at these time points, the object associated with the input values of FIG. 5 will be ranked higher at time point 32 than the other time points 26, 28, 30, and 34. Thus, as illustrated in FIGS. 4 and 5, a user is allowed to submit multiple input values for a single object within the same time interval, such as the time interval 32 in FIGS. 4 and 5.

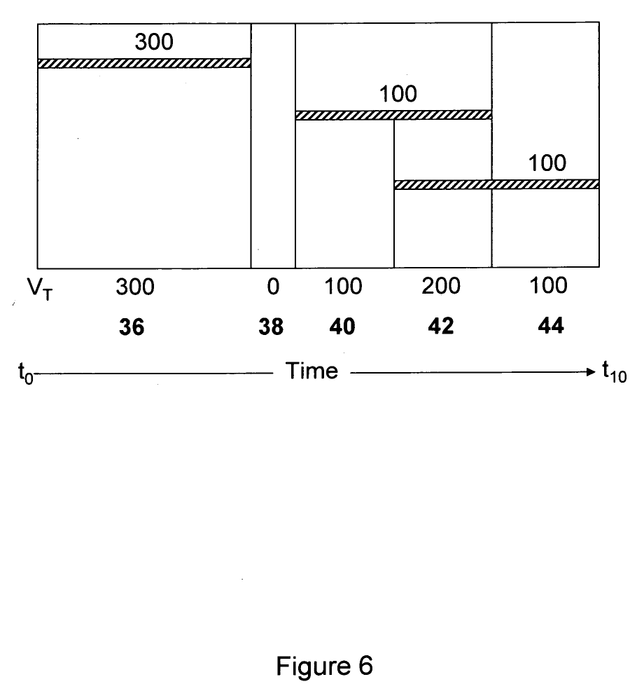

In addition to whether a particular Amount Value (V_{A}) overlaps with and will be added to another Amount Value (V_{A}) at a given time point (t), such as time point 32 in FIG. 5, the absolute value of each Amount Value (V_{A}) will further influence the Value Total (V_{T}). For example, referring to FIG. 6, assuming that all other objects in a listing of objects have constant Value Totals (V_{T}), i.e., such Value Totals (V_{T}) do not change, from t₀ to t₁₀, the object represented by the chart in FIG. 6 would rank higher at time point 36 then it would at time point 42. In addition, the object would rank higher at time point 42 than it would at time points 40 or 44. The foregoing hierarchy would result, despite the fact that the Value Total (V_{T}) at time point 42 benefits from the summation of two separate Amount Values (V_{A}), because the absolute value of the Amount Value (V_{A}) at time point 36 is greater than the sum of the two Amount Values (V_{A}) at time point 42.

Objects that exhibit the same Value Total (V_{T}) at a particular time point may be ranked according to an auxiliary set of rules. For example, among two or more objects that exhibit the same Value Total (V_{T}) at a particular time point, the object that is ranked first may be the object that (1) has assigned to it an Amount Value (V_{A}) that will be the first to expire among all Amount Values (V_{A}) included in the Value Totals (V_{T}) for all such objects, (2) exhibits a Value Total (V_{T}) having the longest time interval (i.e., it will maintain the same Value Total (V_{T}) for the longest period of time relative to the Value Totals (V_{T}) for the other objects), or (3) is correlated with the earliest-registered Amount Value (V_{A}). The plurality of objects having the same Value Total (V_{T}) at a particular time point may be ranked according to the foregoing criteria—or other criteria.

The invention provides that the input values (Amount Values (V_{A})) may represent monetary values. For example, in a system employing the methods described herein to rank on-line advertisements, the advertisers that pay a greater amount, i.e., submit input values (Amount Values (V_{A})), at a particular time point, to achieve a relatively higher Value Total (V_{T}), will be ranked higher than other advertisers that pay a lesser amount, i.e., submit input values (Amount Values (V_{A})) that, at a particular time point, achieve a relatively lower Value Total (V_{T}).

According to further aspects of the present invention, specific applications for the bidding and ranking systems described herein are provided. That is, while the foregoing has described the ranking system of the present invention being applied to any of various objects generally, the invention further encompasses specific applications for such methods. For example, the invention encompasses bidding and ranking systems that are particularly designed for on-line advertisements and internet search keywords. For example, according to such embodiments, the methods described herein may be used to rank on-line advertisements, or internet search results, in a computing environment. For example, such methods may comprise the use of a dedicated server (or group of servers) that receives input values from a plurality of users. According to such embodiments, each input value is preferably correlated with an advertisement (or internet search keyword) during a defined time interval. As described above, the input values (Amount Values (V_{A})) and specified time intervals may be submitted to a server via on-line forms that may be accessed within one or more websites. In such embodiments, each object will preferably be associated with a single user, such as a business entity (advertiser). The methods further comprise calculating a sum of the input values associated with each advertisement (or internet search keyword) at defined time points, and then ranking each advertisement (or internet search keyword) based on the sum of the input values associated therewith.

Such embodiments will provide a real-time and dynamic bidding systems, which advertisers may use to influence the ranking of advertisements. In the case of internet search keywords, the invention provides that a user which achieves the highest Value Total (V_{T}) for a particular keyword will, for example, benefit by the system ranking the user's specified website first among a listing of websites that is returned when a third party enters the keyword into an internet search engine. In other words, the resulting hierarchy of user Value Totals (V_{T}) at a particular time point (t) will be correlated with a hierarchy of website listings that is returned when the subject keyword is used in an internet search.

According to still further aspects of the present invention, systems are provided that may be used to carryout the methods described herein. The systems of the present invention may generally comprise, for example, a server and a database, which together are capable of receiving the input values and deriving the value totals described herein, and generating a dynamic ranking of objects. The ranking may be displayed to users in a graphical user interface, such as a website, which may be viewed within any computing device. Non-limiting examples of such computing devices, which also may form part of the systems described herein, include personal computers, cell phones, smart phones, PDAs, and other devices that are capable of accessing the internet.

The invention provides that the implementation of the methods described herein may be facilitated through the use of a website. As previously described, the invention provides that users may select desired input values (Amount Values (V_{A})) from a menu of options, e.g., a menu of various dollar amounts, which may be selected using an on-line drop down list (or other HTML form components). Similarly, the time interval that will be assigned to each input value (Amount Values (V_{A})) may be selected from a predefined menu of options, which also may be carried out in a website using any of a variety of different HTML form components. The invention provides that the means by which a user identifies the object to which input values (Amount Values (V_{A})) will apply may vary. For example, if the object is an on-line advertisement, a website may be provided which comprises a unique and password-protected account page for each user. Within the account page, the user may be allowed to create, or upload, a desired advertisement, which shall serve as the object to be ranked in accordance with the input values (Amount Values (V_{A})) assigned thereto by the user.

The methods and systems of the present invention may be further illustrated by the following non-limiting example, which should not be interpreted to limit the scope of the invention in any way.

### EXAMPLE

In this Example, the methods described herein are applied to a bidding system for internet search keywords, wherein the keywords are associated with internet advertisements (i.e., when an internet user conducts a search using such keyword, the search results include a listing (ranking) of advertisements that are associated with such keyword). To begin, a user enters a desired keyword and corresponding Amount Value (V_{A}), which represents a monetary value that the user is willing to pay for such keyword. More particularly, in this Example, the Amount Value (V_{A}) represents a monetary value that the user is willing to pay when, after being presented with an advertisement associated with the subject internet search keyword, an internet searcher “clicks” on the advertisement, i.e., a conventional pay-per-click type of model. In this Example, another user enters the same desired keyword, and its own corresponding Amount Value (V_{A}), for the purpose of attempting to cost-effectively generate the highest Value Total (V_{T}) and corresponding ranking associated with such keyword. Specifically, the two users take the following actions:

User-1 enters an Amount Value (V_{A}) of $100 on January 1 for the desired keyword, and specifies a time interval of 30 days (approximately $3.33 per day). At that time, User-1 is the only user that assigns (purchases) an Amount Value (V_{A}) for the keyword, so User-1 ranks first in internet search result listings—i.e., its advertisement (which is correlated with the keyword) is ranked first in internet search result listings. Next, User-2 enters an Amount Value (V_{A}) of $101 on January 2 for the same keyword for its advertisement, and specifies a time interval of 30 days (approximately $3.37 per day). As such, the Value Total (V_{T}) for User-2 is higher at that time point, thereby causing User-2 (or, more particularly, its advertisement associated with such keyword) to be ranked first (in front of User-1, which is now ranked second). On January 3, User-1 decides to enter an additional Amount Value (V_{A}) of $3 (adding $0.10 per day) to create a Value Total (V_{T}) (approximately $3.43 per day) that exceeds the Value Total (V_{T}) of User-2 (approximately $3.37 per day), and specifies a time interval of 30 days. Therefore, at that point, User-1 is ranked first with a Value Total (V_{T}) of $103, in front of User-2 with a Value Total (V_{T}) of $101.

User-1's Amount Value (V_{A}) of $100 eventually expires 30 days later (leaving its Value Total (V_{T}) at just $3). As a result, at that time, User-2 is ranked first, with a Value Total (V_{T}) of $101, and User-1 drops to the second ranking. Next, User-2's Amount Value (V_{A}) of $101 expires, which then causes User-1 to ascend back to a first ranking with a Value Total (V_{T}) of $3, and User-2 with $0. The foregoing is a simplified example of the methods described herein, but should illustrate the dynamic and user-controllable nature of the ranking system of the present invention.

It is to be understood that both the general description and the detailed description are exemplary and explanatory, but are not restrictive of the invention. The invention in its broader aspects is not limited to the specific details shown and described, and departures may be made from such details without departing from the principles of the invention and without sacrificing its chief advantages.

What is claimed is:

1. A method of ranking objects in a computing environment, which comprises:
(a) receiving input values from a plurality of users, wherein each input value is correlated with an object and a defined time interval, wherein each object may only be correlated with input values submitted by a single user;
(b) calculating a value total at a plurality of time points within the defined time interval, wherein the value total is a sum of the input values assigned to each object at a single time point; and
(c) ranking each object at each of the plurality of time points, wherein the objects are ranked in accordance with the value total for each of the objects at each time point.

2. The method of claim 1, wherein each user is allowed to submit multiple input values for a single object.

3. The method of claim 2, wherein each user is allowed to submit multiple input values for a single object within a single defined time interval.

4. The method of claim 3, wherein the user selects a beginning and end point for the defined time interval for each input value.

5. The method of claim 3, wherein a beginning point for the defined time interval for an input value is the date on which the input value is submitted to a server, while the user is allowed to select an end point for the defined time interval for the input value.

6. The method of claim 3, wherein a first object is ranked higher than a second object at a first time point, if a value total correlated with the first object at the first time point is higher than a value total correlated with the second object at the first time point.

7. The method of claim 6, wherein the time point is a period of time selected from the group consisting of a second, minute, hour, day, and week.

8. The method of claim 7, wherein each object is ranked upon commencing each successive time point based on the value totals assigned to each object.

9. The method of claim 8, wherein the object is an on-line advertisement, personal name within an on-line directory, a business name within an on-line directory, uniform resource locator, internet search keyword, or a combination thereof.

10. The method of claim 3, wherein a ranking of a plurality of objects is displayed in a graphical user interface.

11. The method of claim 3, wherein the input value is a monetary figure.

12. A method of ranking advertisements in a computing environment, which comprises:
(a) receiving input values from a plurality of users, wherein each input value is correlated with an advertisement and a defined time interval, wherein each advertisement may only be correlated with input values submitted by a single user;
(b) calculating a value total at a plurality of time points within the defined time interval, wherein the value total is a sum of the input values assigned to each advertisement at a single time point; and
(c) ranking each advertisement at each of the plurality of time points, wherein the advertisements are ranked in accordance with the value total for each of the advertisements at each time point.

13. The method of claim 12, wherein each user is allowed to submit multiple input values for a single advertisement within the defined time interval.

14. The method of claim 13, wherein the user selects a beginning and end point for the defined time interval for an input value.

15. The method of claim 13, wherein a beginning point for the defined time interval for an input value is the date on which the input value is submitted to a server, while the user is allowed to select an end point for the defined time interval for the input value.

16. The method of claim 15, wherein a first advertisement is ranked higher than a second advertisement at a first time point, if a value total correlated with the first advertisement at the first time point is higher than a value total correlated with the second advertisement at the first time point.

17. The method of claim 16, wherein the time point is a period of time selected from the group consisting of a second, minute, hour, day, and week, and wherein each advertisement is ranked upon commencing each successive time point based on the value total assigned to each advertisement.

18. The method of claim 17, wherein the advertisement is a pay-per-click advertisement.

19. The method of claim 18, wherein a ranking of a plurality of advertisements is displayed in a graphical user interface.

20. The method of claim 19, wherein the input value is a monetary figure.
